(19) United States
(12) Patent Application Publication
(10) Pub. No.: US 2018/0243171 A1
(43) Pub. Date: Aug. 30, 2018

(54) PACKAGES WITH MONITORING DEVICES

(71) Applicant: WestRock MWV, LLC, Norcross, GA (US)

(72) Inventors: James D. Knotts, Glen Allen, VA (US); Elizabeth A. Vercoe, Richmond, VA (US); Nicolas Tille, Saviese (CH); John W. Musaus, Raleigh, NC (US)

(21) Appl. No.: 15/553,448

(22) PCT Filed: Feb. 5, 2016
(86) PCT No.: PCT/US16/16733

§ 371 Date: Aug. 24, 2017

Related U.S. Application Data
(60) Provisional application No. 62/121,670, filed on Feb. 27, 2015.
(60) Provisional application No. 62/171,362, filed on Jun. 5, 2015.

(51) Int. Cl. A61J 7/04; A61J 1/03; B65D 5/38; B65D 83/04

(52) U.S. Cl. CPC A61J 7/0436; A61J 1/035; B65D 2583/0468; B65D 83/0463; A61J 2200/30; B65D 5/38

(57) ABSTRACT

A package includes an outer sleeve with a slide card slidingly received in the outer sleeve. A monitoring device is operatively connected to the package to generate data indicative of use of the package. A switch is electrically connected to the monitoring device for activating and deactivating the monitoring device. The at least part of the switch is secured to the slide card such that the switch is operated to activate or deactivate the monitoring device by at least one of translating movement of the slide card relative to the outer sleeve or transforming movement of the slide card. Another exemplary package includes an outer sleeve with a slide card slidingly received in the outer sleeve. A monitoring device is detachably attached to the slide card to generate data indicative of use of the package.

### REFERENCE TO RELATED APPLICATIONS

This application claims the benefit of priority under 35 U.S.C. § 119(e) of U.S. provisional applications Ser. No. 62/121,670 filed on Feb. 27, 2015 and 62/171,362 filed on Jun. 5, 2015, both of which are hereby incorporated by reference in their entireties.

### BACKGROUND OF THE INVENTION

### Field of the Invention

The present disclosure relates to packaging, and more particularly to monitoring usage of packages such as in dosing monitors for pharmaceutical packaging.

### Description of Related Art

Various systems and methods can be used for tracking the usage and delivery of medications. Mechanical dispensing systems and, more recently, pharmaceutical packages with various electronic monitoring features have been developed for such purposes. Examples of packages are described in U.S. Pat. No. 6,752,272, and examples of packages with electronic circuitry, e.g., for monitoring dosing, are described in U.S. Pat. No. 7,552,824, each of which is incorporated by reference herein in its entirety.

With regard to pharmaceutical packages that incorporate electronic monitoring features, it is known to construct an apparatus for dispensing medications from a uniquely shaped single foldable sheet that includes an internal electronic circuit. Further, it is known to construct a multi-layer protective seal which likewise includes an internal electronic circuit. Although the known devices create unique packages and provide certain features, they do not provide solutions that can be cost-effectively integrated into standard manufacturing processes or used together with existing package configurations. The above referenced U.S. Pat. No. 7,552,824 presents solutions to these needs in the art.

Such methods and systems have generally been considered satisfactory for their intended purpose. However, there is an ongoing need in the art for improved monitoring systems for packaging pharmaceuticals and the like. The present disclosure provides a solution for this need.

### SUMMARY

A package includes an outer sleeve with a slide card slidingly received in the outer sleeve. A monitoring device is operatively connected to the package to generate data indicative of use of the package. A switch is electrically connected to the monitoring device for activating and deactivating the monitoring device. The at least part of the switch is secured to the slide card such that the switch is operated to activate or deactivate the monitoring device by at least one of translating movement of the slide card relative to the outer sleeve or transforming movement of the slide card.

In accordance with certain aspects, the monitoring device can be configured to record the time and date when the monitoring device is activated and/or deactivated. For example, the monitoring device can be configured to record the time and date when the package is opened. It is also contemplated that the monitoring device can be configured to transmit a signal indicating the time and date when the monitoring device is activated and/or deactivated. For example, the monitoring device can be configured to transmit a signal indicating the time and date when the package is opened.

In another aspect, in a first position, the slide card is within the outer sleeve. In a second position the slide card is slid at least partially outside of the outer sleeve.

In certain embodiments, the switch is a magnetic, reed switch or magnetic, solid state switch such as a Hall-effect switch. The package can include a magnet operatively connected to the package to actuate the switch. The monitoring device can be mounted to the slide card for common movement therewith relative to the outer sleeve. The magnet can be mounted to the outer sleeve such that in the first position, the monitoring device and magnet are in proximity with one another, and in the second position, the monitoring device and magnet are spaced apart from one another to actuate the switch. For example, in the first position, the magnet and monitoring device are both proximate a closed end of the outer sleeve. In another example, in the first position, the magnet and monitoring device are both proximate an open end of the outer sleeve. It is also contemplated that the monitoring device can be mounted to the outer sleeve, and the magnet can be mounted to the slide card.

A card flap can be hingedly connected to the slide card. In the first position, the slide card is within the outer sleeve with the card flap folded over the slide card, and in the second position the slide card is slid at least partially outside of the outer sleeve with the card flap folded over the slide card but clear from the outer sleeve. In a third position, the slide card is at least partially outside the outer sleeve and the card flap is folded open from the slide card. The monitoring device can be mounted to the slide card for common movement therewith relative to the outer sleeve. A magnet can be mounted to one of the card flap and the slide card and the monitoring device can be mounted to the other of the card flap and slide card so that in the first and second positions the monitoring device and magnet are in close proximity and in the third position the magnet and monitoring device are spaced apart from one another to actuate the switch.

In another exemplary embodiment, the switch is a mechanical switch. The switch can include a sloped cam surface that in the first position is pressed toward the monitoring device by the outer sleeve, and in the second position is biased outward to actuate the switch, wherein the cam surface is configured to cam inward against an open end of the outer sleeve as the slide card moves from the second position to the first position. In embodiments with a card flap hingedly connected to the slide card, as described above, the switch can include a switch element that is pressed inward with respect to the monitoring device in the first and second positions, and wherein the switch is biased outward with respect to the monitoring device in the third position. For example, the switch element can be positioned on the monitoring device to face the card flap in the first and second positions. In another example, the switch element can be positioned on the monitoring device to face a hinge panel connecting the slide card and the card flap in the first and second positions.

Another exemplary package includes an outer sleeve with a slide card slidingly received in the outer sleeve. A monitoring device is detachably attached to the slide card to generate data indicative of use of the package.

In certain embodiments, the slide card includes a monitoring device receptacle including at least one dovetail rail. The monitoring device includes at least one respective dovetail channel. The dovetail rail and channel are configured for sliding engagement and disengagement of the monitoring device with the slide card. The dovetail rail can include a terminus having a greater rail height than the remainder of the dovetail rail, and the dovetail channel can have a terminus having a greater channel depth than the remainder of the channel. The terminus of the dovetail rail and the terminus of the dovetail channel can engage one another with the monitoring device seated in the receptacle to retain the engagement of the monitoring device and the receptacle while allowing for deliberate disengagement thereof.

In accordance with certain embodiments, the slide card includes a monitoring device receptacle having a plurality of arms configured to engage the monitoring device peripherally, and to release the monitoring device by overcoming a bias in one or more of the arms. The monitoring device can define a substantially circular periphery. For example, the plurality of arms can include three arms that are substantially evenly spaced apart circumferentially.

The monitoring device can include an upper section and a lower section. The lower section can have a smaller area than that of the upper section so that the monitoring device can be removed from the receptacle by pressing laterally against the lower section and applying an upward force against the upper section. The arms of the receptacle can be dimensioned to receive the monitoring device lower section first without force. At least one of the arms of the receptacle can include a first cam surface configured to expand the arm over the upper section of the monitoring device when the monitoring device is advanced into the arms lower section first and a second cam surface configured to resist advancing the monitoring device into the receptacle upper section first. A cam surface can be included on the monitoring device connecting between the upper and lower sections, wherein the cam surface of the monitoring device is configure to cooperate with the first cam surface of the receptacle to facilitate expansion of the one or more arms of the receptacle over the upper section of the monitoring device when the monitoring device is advanced into the receptacle.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1A is a perspective view of an exemplary embodiment of a package constructed in accordance with the present disclosure, showing a monitoring device mounted to the slide card and a corresponding magnet mounted to the card flap for actuating a reed switch in the monitoring device when the flap is moved;

FIG. 1B is a perspective view of the package of FIG. 1A, showing the slide card in a position slid out from the outer sleeve, but with the card flap folded over the slide card;

FIG. 1C is a perspective view of the package of FIG. 1A, showing the slide card slid into the outer sleeve;

FIG. 2 is a perspective view of another exemplary embodiment of the package of FIG. 1, showing an arrangement with the magnet mounted to the outer sleeve for actuating the reed switch when the slide card is moved;

FIG. 3 is a perspective view of another exemplary embodiment of the package of FIG. 1, showing an arrangement with the magnet mounted to the card flap and the monitoring device mounted to an opposite end of the slide card compared to that shown in FIG. 1;

FIG. 4a is a perspective view of another exemplary embodiment of the package of FIG. 1, showing an arrangement with the magnet mounted to the outer sleeve and the monitoring device mounted to an opposite end of the slide card compared to that shown in FIG. 2;

FIG. 4b is a perspective view of another exemplary embodiment of the package of FIG. 1, showing an arrangement with the magnet mounted to the slide card and the monitoring device mounted to the outer sleeve;

FIG. 5 is a perspective view of another exemplary embodiment of the package of FIG. 1, showing a monitoring device with a mechanical switch;

FIG. 6 is a side elevation view of the package of FIG. 5, showing the mechanical switch in a position outside the outer sleeve;

FIG. 7 is a side elevation view of the package of FIG. 5, showing the mechanical switch in a position being pressed inward by the outer sleeve;

FIG. 8 is a side elevation view of another exemplary embodiment of the package of FIG. 5, showing the monitoring device mounted to an opposite end of the slide card from that shown in FIG. 5;

FIG. 9 is a side elevation view of the package of FIG. 8, showing the card flap moved to a position to press the mechanical switch into the monitoring device;

FIG. 10 is side elevation view of another exemplary embodiment of the package of FIG. 8, showing an arrangement with the switch proximate a hinge panel connecting between the slide card and the card flap;

FIG. 11 is a side elevation view of the package of FIG. 10, showing the card flap moved to a position where the hinge panel presses the mechanical switch into the monitoring device;

FIG. 12 is a perspective view of another exemplary embodiment of the package of FIG. 8, showing a push pin switch;

FIG. 13 is a side elevation view of the package of FIG. 12, showing the push pin switch;

FIG. 14 is an exploded, perspective view of the slide card of FIG. 1, showing the blister packs, the receptacle for a monitoring device, the magnet, and the blank for the slide card;

FIG. 15 is a perspective view of the slide card of FIG. 14, showing the blister packs and monitoring device receptacle positioned on the blank;

FIG. 16 is a perspective view of the slide card of FIG. 14, showing the slide card being assembled with the magnet and receptacle mounted thereto;

FIG. 17 is a side elevation view of the receptacle of FIG. 14, showing the dovetail rails;

FIG. 18 is an end elevation view of the receptacle of FIG. 17, showing the terminus of the dovetail channels;

FIG. 19 is a top plan view of the receptacle of FIG. 17, showing the dovetail rails;

FIG. 20 is a side elevation view of the monitoring device of FIG. 1, showing the dovetail channels;

FIG. 21 is an end elevation view of the monitoring device of FIG. 20, showing the terminus of dovetail channels;

FIG. 22 is a bottom plan view of the monitoring device of FIG. 20, showing the dovetail channels;

FIGS. 23-25 are perspective views of the package of FIG. 1, showing three stages in assembling the removable monitoring device to the slide card;

FIG. 26 is a perspective view of another exemplary embodiment of a monitoring device and receptacle, showing the receptacle arms holding the monitoring device in place;

FIG. 27 is a perspective view of the monitoring device of FIG. 26, showing how force can be applied to lift the monitoring device upward to remove it from the receptacle;

FIG. 28 is a side elevation view of the monitoring device and receptacle of FIG. 26, showing the monitoring device entering the receptacle;

FIG. 29 is a side elevation view of the monitoring device and receptacle of FIG. 28, showing the monitoring device removably mounted in the receptacle;

FIGS. 30 and 31 are side elevation views of the monitoring device of FIG. 26, showing the operation of the cam surfaces to admit proper insertion and deny improper insertion of the monitoring device, respectively; and

FIGS. 32-37 show various methods for attaching the monitoring device or receptacle.

### DETAILED DESCRIPTION OF THE PREFERRED EMBODIMENTS

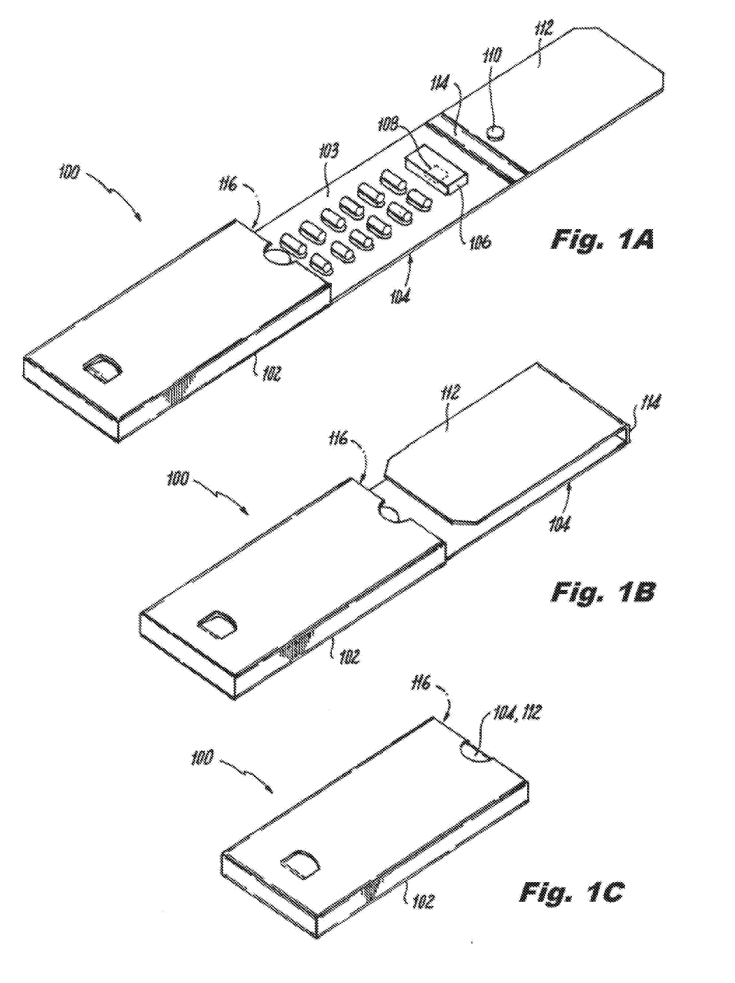

Reference will now be made to the drawings wherein like reference numerals identify similar structural features or aspects of the subject disclosure. For purposes of explanation and illustration, and not limitation, a partial view of an exemplary embodiment of a package in accordance with the disclosure is shown in FIG. 1A and is designated generally by reference character 100. Other embodiments of packages in accordance with the disclosure, or aspects thereof, are provided in FIGS. 1B, 1C, and 2-31, as will be described. The systems and methods described herein can be used for monitoring usage of packages, such as in dosage monitoring for pharmaceutical products.

Package 100 includes an outer sleeve 102 with a slide card 104 slidingly received in outer sleeve 102. A monitoring device 106 is operatively connected to slide card 104 to generate data indicative of use of package 100, e.g., for dosage monitoring in pharmaceutical packaging. A switch 108 is electrically connected to monitoring device 106 for activating and deactivating monitoring device 106. Switch 108 is secured to slide card 104 such that switch 108 is operated to activate or deactivate monitoring device 106 by at least one of translating movement of slide card 104 relative to outer sleeve 102 or transforming movement of slide card 104. Switch 108 is shown schematically in broken lines in FIG. 1 because it is a magnetic reed switch or magnetic solid state switch (such as a Hall-effect switch) internal to monitoring device 106, and includes a magnet 110 as a part thereof which actuates the reed, as explained further below.

Monitoring device 106 can be configured to record the time and date when the monitoring device 106 is activated and/or deactivated. For example, monitoring device 106 can be configured to record the time and date when package 100 is opened, e.g., to assist in keeping track of whether an individual has taken a prescribed dose of medication from package 100 or not. It is also contemplated that monitoring device 100 can be configured to transmit a signal indicating the time and date when monitoring device 106 is activated and/or deactivated. For example, monitoring device 106 can be configured to transmit a signal indicating the time and date when package 100 is opened. The signal can be transmitted wirelessly using any suitable wireless protocol such as Wi-Fi or Bluetooth, for example, to a device such as a general purpose computer that can track the usage of package 100. The signal can be transmitted immediately, or at a later time. It is also contemplated that the signal can be transmitted over a wire, such as using a USB connection between monitoring device 106 and a device such as a general purpose computer. Package 100 and monitoring device 106 do not therefore need to have a display for providing output, since the data can be displayed on whatever device the data is transferred to. However, it is contemplated that package 100 can optionally include a display for providing a visual output.

Monitoring device 106 is mounted to slide card 104 for common movement therewith relative to outer sleeve 102. A card flap 112 is hingedly connected to slide card 104, e.g., card flap 112 is part of the slide card 104, wherein it is the base portion 103 of slide card 104 from which card flap 112 extends. In the first position shown in FIG. 1C, slide card 104 is within outer sleeve 102 with card flap 112 folded over base portion 103 of slide card 104. In the second position, shown in FIG. 1B, slide card 104 is slid at least partially outside of outer sleeve 102 with the card flap 112 folded over base portion 103 of slide card 104 but clear from outer sleeve 102. In a third position, slide card 104 is at least partially outside outer sleeve 102 and card flap 112 is folded open from base portion 103 of slide card 104, as shown in FIG. 1A.

In certain embodiments, the switch is magnetic, e.g., a reed switch, which comprises a switch main 108 and a magnet 110. The switch main 108 is a part that contains encased metal reeds or contacts which are actuated by the magnet 110. Alternately, the switch main 198 may be a solid state device actuated by the magnet 110. The magnet 110 is operatively connected to package 100 to actuate the contacts in the switch main 108. In the embodiment of FIGS. 1A, 1B and 1C, magnet 110 is mounted to card flap 112 and monitoring device 106 which contains the switch main 108 is mounted to base portion 103 of slide card 104, however, this could optionally be reversed. In the first (or retracted) and second (or withdrawn) positions, shown in FIGS. 1C and 1B respectively, monitoring device 106 and magnet 110 are in close proximity and in the third (or withdrawn-and-opened) position shown in FIG. 1A, magnet 110 and monitoring device 106 are spaced apart from one another to actuate (i.e., open or close) switch main 108. It is by transforming, e.g., opening and closing card flap 112 relative to the base portion 103 of slide card 104, the switch main 108 is actuated, which can for example increment a count and/or generate date and time data in monitoring device 106.

Package 100 has monitoring device 106 and magnet 110 mounted proximate, and optionally on the opposite sides of, hinge panel 114 that connects between base portion 103 of slide card 104 and card flap 112. Therefore, in the first position (shown in FIG. 1C) wherein the card flap 112 is closed and the slide card 104 is fully retracted or received in outer sleeve 102, monitoring device 106 and magnet 110 are proximate each other and both proximate the open end 116 of outer sleeve 102 so that switch main 108 takes one of its closed and opened positions. To bring switch main 108 to the other of its closed and opened positions, the slide card 104 may be translated to the second position (FIG. 1B) wherein slide card 104 is withdrawn at least in part from the outer sleeve 102 and then may be transformed to take the third position (FIG. 1A) wherein card flap 112 is opened with respect to base portion 103. Thus the embodiment shown in FIGS. 1A-1C is particularly adapted to detecting when the slide card 104 and card flap 112 are moved relative to one another. However, it does not directly detect when the slide card is withdrawn from or inserted into the outer sleeve 102.

An alternative exemplary embodiment of a package 300 is shown in FIG. 3, in which monitoring device 306 (which contains a switch main) is mounted to base portion 303 of slide card 304 at a location remote from hinge panel 314 while magnet 310 is mounted to card flap 312 at a location remote from hinge panel 314. As such, in the closed and retracted position, e.g., as in FIG. 1C, the monitoring device 306 and magnet 310 are proximate each other and proximate the closed end 318 of outer sleeve 302, although monitoring device 306 is activated/deactivated by the transforming movement of slide card 304, i.e., the opening/closing movement of card flap 312 with respect to base portion 303, much as described above with respect to FIGS. 1A-1C.

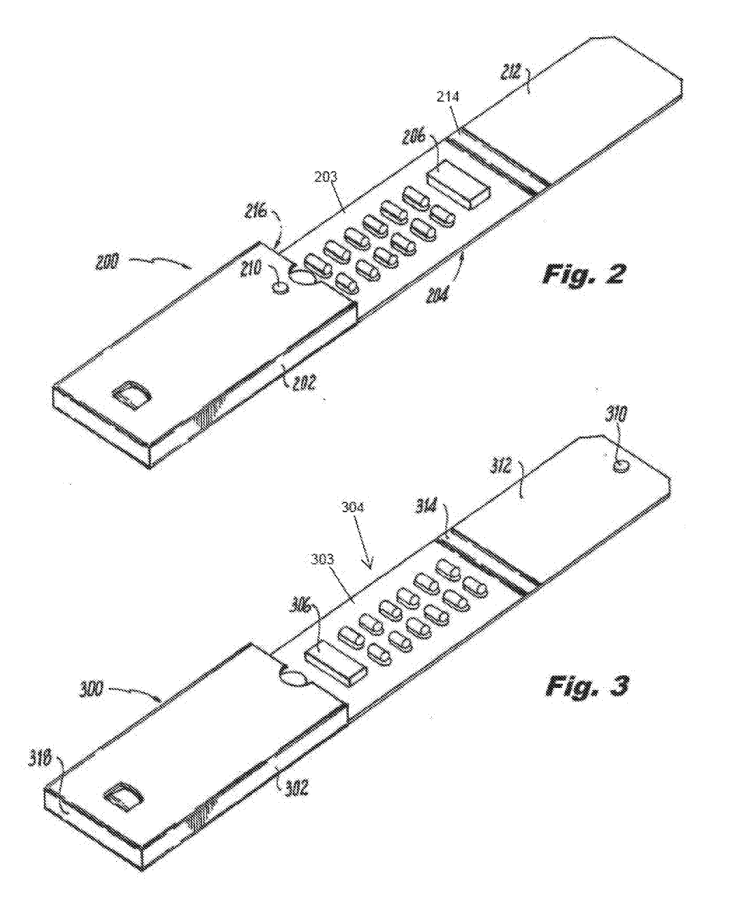

With reference to FIG. 2, it is also possible to have an arrangement where the switch is actuated by translating/sliding movement of the slide card, rather than the transforming movement of the slide card such as the folding and unfolding of the card flaps as described above. In package 200, in a first position (not shown but see FIG. 1C), slide card 204 is within outer sleeve 202. In a second position, e.g., as shown in FIG. 2 and see also FIG. 1B, slide card 204 is withdrawn at least partially from outer sleeve 202. In FIG. 2, magnet 210 is mounted to outer sleeve 202 proximate its open end 216, optionally to its inside surface, while monitoring device 206 (which contains a switch main) is mounted to base portion 203 at a location proximate hinge panel 214. As such, in the first position, the monitoring device 206 and magnet 210 are in proximity with one another, and in the second position, monitoring device 206 and magnet 210 are spaced apart from one another to actuate the switch, e.g., regardless of the position of card flap 212. In this example, in the first position, magnet 210 and monitoring device 206 are both proximate the open end 216 of the outer sleeve 202.

Thus it may be understood that the arrangement in FIG. 2 will be able to detect when the slide card 204 is completely within outer sleeve 202, and the times at which the slide card is started out of the sleeve or completely slid into the sleeve. The detecting action will occur regardless of the position of card flap 212. Such an arrangement may be particularly useful when some child resistance is desired with the package, since the detecting action determines whether or not the slide card is accessible for removing its contents. However, if a customer pulls slide card 204 from outer sleeve 200 simply to check whether they have taken their medicine on schedule, or to read information printed on the outer surfaces of the slide card 204, then the arrangement on FIG. 2 may provide inconclusive data regarding consumption of the medicine.

If an additional magnet is positioned on the card flap 212, optionally with an additional switch main on the monitoring device 206, the system may be able to detect both the position of the slide card 204 relative to sleeve 200, and also the position of the card flap 212 relative to slide card 204.

The arrangement in FIG. 3 on the other hand permits a customer to withdraw slide card 304 from outer sleeve 200, review instructions on the outside surfaces of the slide card 304, or check whether medication has been taken (by looking at the underside of slide card 304), all without necessarily opening the card flap 212 and triggering a signal regarding consumption of the medication.

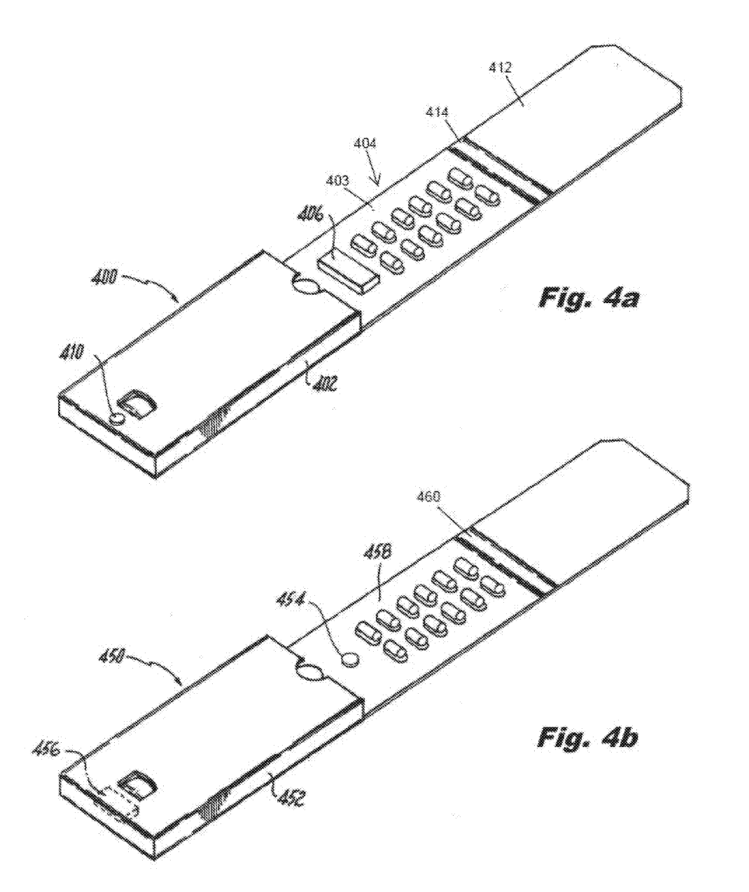

In FIG. 4a which shows another exemplary package 400, magnet 410 is mounted on outer sleeve 402 proximate its closed end while monitoring device 406 (containing a switch main) is mounted on base portion 403 of slide card 404 at a location remote from hinge panel 414 such that magnet 410 and monitoring device 406 are both proximate the closed end of the outer sleeve 402. Reference numeral “412” denotes a card flap.

As shown in FIG. 4b which shows another exemplary package 450, it is also contemplated that monitoring device 456 can be mounted to the inside of the outer sleeve 452, and magnet 454 can be mounted to the slide card 458 of package 450 at a location remote from hinge panel 460, for example.

While five exemplary arrangements of magnets and monitoring devices are shown and described herein, those skilled in the art will readily appreciate that any other suitable locations for mounting monitoring devices and magnets can be used without departing from the scope of this disclosure. Card flaps and hinge panels, e.g., card flap 212 and hinge flap 114, are optional in embodiments such as shown in FIGS. 2 and 4a where the magnet, e.g., magnets 210 and 410, are mounted to the outer sleeve. As previously noted, more than one magnet may be utilized, to act upon one or more switch mains.

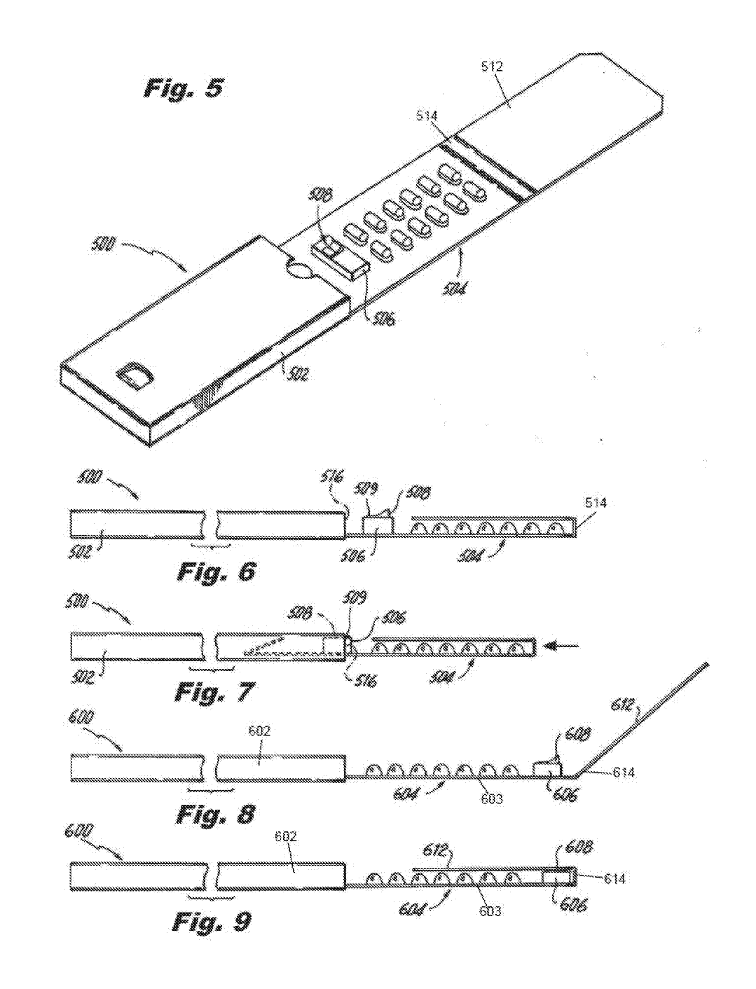

With reference now to FIG. 5, another exemplary embodiment of a package 500 which includes an outer sleeve 502, slide card 504, and monitoring device 506 as described above except the switch is not a magnetic switch. The switch 508 used with this embodiment is a mechanical switch, specifically a biased or spring-loaded switch. Switch 508 is mounted on the housing of monitoring device 506 which in turn is mounted to the base portion of slide card 504 at a location remote from hinge panel 514. Switch 508 is mechanically biased outward from monitoring device 506 and includes a sloped cam surface 509, identified in FIG. 6. In the first position, e.g., as shown in FIG. 7, switch 508 is pressed against the biasing force toward the monitoring device 506 by the outer sleeve 502 acting on cam surface 509. In the second position, shown in FIGS. 5 and 6, switch 508 is pivoted upward/outward due to the biasing force to actuate switch 508 by movement of slide card 504 into and out of outer sleeve 502. Cam surface 509 is configured to cam inward against an open end 516 of outer sleeve 502 as the slide card moves from the second position to the first position. Reference numeral “512” denotes a card flap.

Referring to FIG. 8, another embodiment of a package 600 includes a card flap 612 hingedly connected to the base portion 603 of the slide card 604 via hinge panel 614, as described above. Mechanical switch 608 includes a biased switch element that is pressed inward against the biasing force by means of card flap 612 that is in the closed position shown in FIG. 9. In the closed position of FIG. 9, card flap 612 is folded over base portion 603 to take a position where it is generally parallel to base portion 603. Switch 608 is biased upward (i.e., outward with respect to monitoring device 606) against card flap 612 when the card flap 612 is in the closed position (FIG. 9). The switch element is mounted on the housing of monitoring device 606 to face card flap 612 in the closed position. When card flap 612 is moved to its opened position shown in FIG. 8, switch 608 is released from the pressing force of card flap 612 and returns to its initial position where the switch element projects upward from the housing of the monitoring device 606, which is best shown in FIG. 8. In the opened position, card flap 612 is no longer parallel with base portion 603 but is disposed aside at an angle (e.g., an obtuse angle) with respect to base portion 603. Switch 608 in this embodiment is operated by the transforming movement of slide card 604, i.e., the closing and opening movement of card flap 612. Reference numeral “602” denotes an outer sleeve while reference numeral “614” denotes a hinge panel.

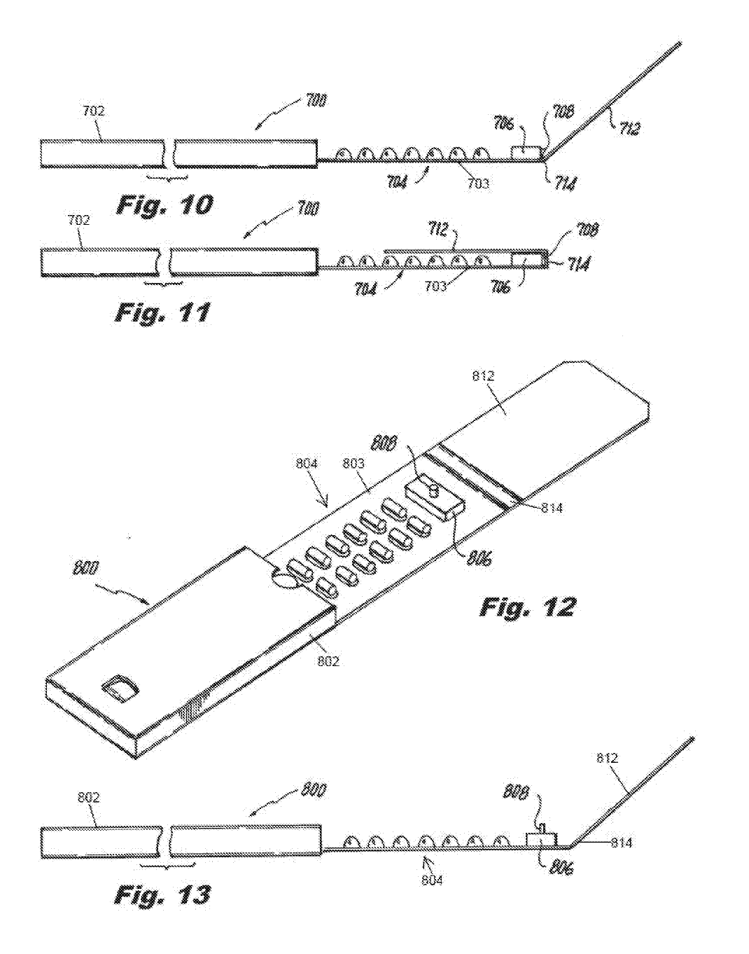

In another example, namely package 700 shown in FIG. 10, the mechanically biased switch element of mechanical switch 708 is positioned on the side wall of the housing of the monitoring device 706 to face a hinge panel 714 that connects between the base portion 703 and card flap 712. When card flap 712 is in the closed position as shown in FIG. 11, the switch element of switch 708 is pressed by hinge panel 714 toward monitoring device 706 against the biasing force. When card flap 712 is moved to the opened position as shown in FIG. 10, the switch element is released from hinge panel 714 and returns to the initial position where it protrudes from the side wall of the monitoring device 706 as shown in FIG. 10. Switch 708 in this embodiment is operated by the transforming movement of slide card 704, i.e., the pivotal movement of hinge panel 714 that is caused by the closing and opening movement of card flap 712. Reference numeral “702” denotes an outer sleeve.

It is contemplated that the switch can optionally be a push pin type biased switch, e.g., in lieu of those switches shown in FIGS. 8-11. FIGS. 12 and 13 show an exemplary package 800 with a monitoring device 806 having a biased push pin switch 808, which is otherwise similar to package 600 described above. If used in a configuration such as shown in FIGS. 6 and 7, the biased push pin switch 808 may have a rounded or sloped end allowing a smooth travel into outer sleeve 502.

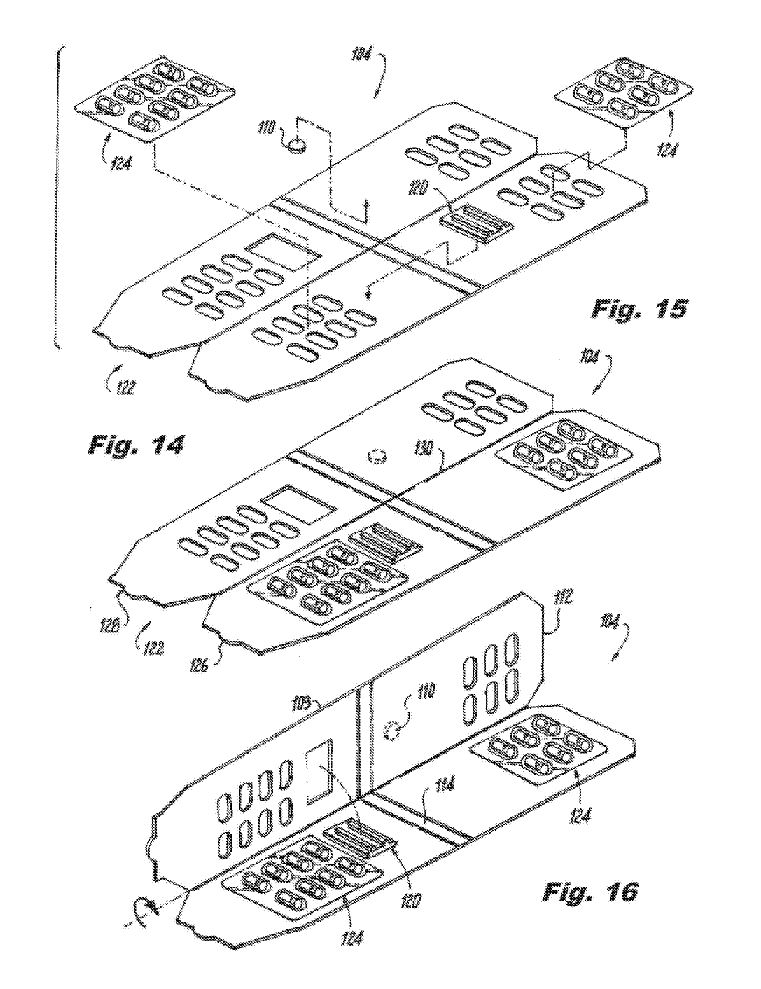

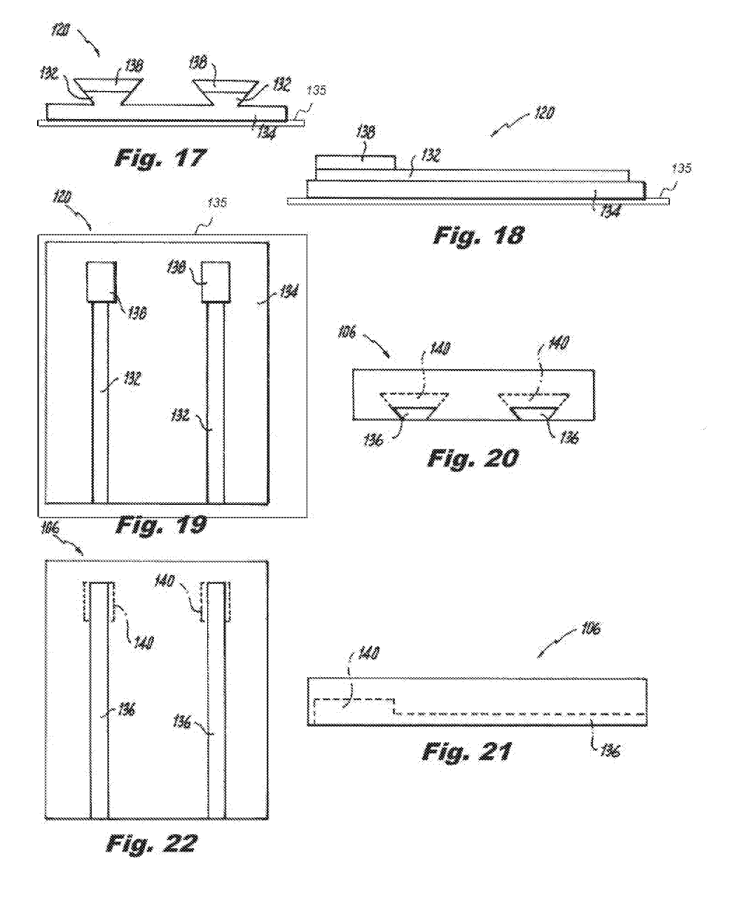

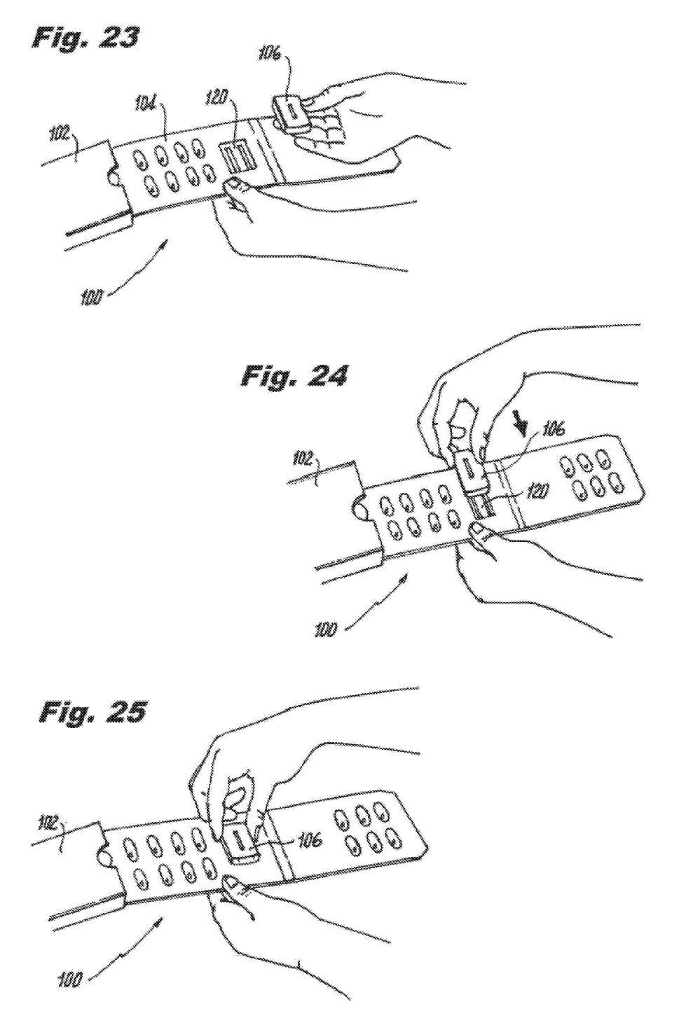

Referring now to FIG. 14, monitoring device 106 is removable from package 100. Slide card 104 includes a monitoring device receptacle 120. Packs 124, e.g., blister packs each with a blister card sandwiched by a pair of substrate panels to contain pills or tablets, and receptacle 120 can be positioned onto blank 122, as shown in FIG. 15. Blank flap 128 can then be folded over onto blank flap 126 along fold line 130 and can be secured thereto using an adhesive, heat sealing, or the like, to form slide card 104 as indicated in FIG. 16. Magnet 110 can be adhered, heat sealed, or the like between flaps 126 and 128, or can be adhered, heat sealed, or the like, on the outer surface of flap 128 as indicated in FIG. 16, to form the slide card 104 as it is shown in FIG. 23. Likewise monitoring device receptacle 120 may be secured to blank flap 126 as shown, by adhesive, heat sealing, or the like. Additionally or in the alternative, monitoring device receptacle 120 may include a peripheral flange 135 (see FIGS. 17-19) to be trapped between blank flaps 126, 128.

As shown in FIGS. 17-19, receptacle 120 includes a pair of dovetail rails 132 extending from a base 134. Monitoring device 106 includes respective dovetail channel 136, as shown in FIGS. 20-22. The dovetail rails 132 and channel 136 are configured for sliding engagement and disengagement of the monitoring device 106 with the slide card 104. The dovetail rails each include a terminus 138 having a greater rail height, e.g., relative to base 134, than the remainder of the dovetail rail 132. Similarly, the dovetail channels 136 each have a terminus 140 having a greater channel depth than the remainder of the channel 136. The terminus 138 of the dovetail rails 132 and the terminus 140 of the dovetail channels 136 can engage one another with the monitoring device 106 seated in the receptacle 120 to retain the engagement of the monitoring device 106 and the receptacle 120 while allowing for deliberate disengagement thereof. With monitoring device 106 oriented with the channel openings as shown in FIG. 23, to slide first over the terminus 138 of dovetail rails 132 of receptacle 120 as shown in FIG. 24, monitoring device 106 can be secured in receptacle 120 with each rail terminus 138 engaged in each respective channel terminus 140 as shown in FIG. 25. This will resist non-deliberate disengagement of monitoring device 106 from slide card 104, but will allow deliberate disengagement thereof by reversing the steps shown in FIGS. 23-25. In this manner, a single monitoring device 106 can be used successively with multiple packages 100 as the contents thereof are consumed, for example.

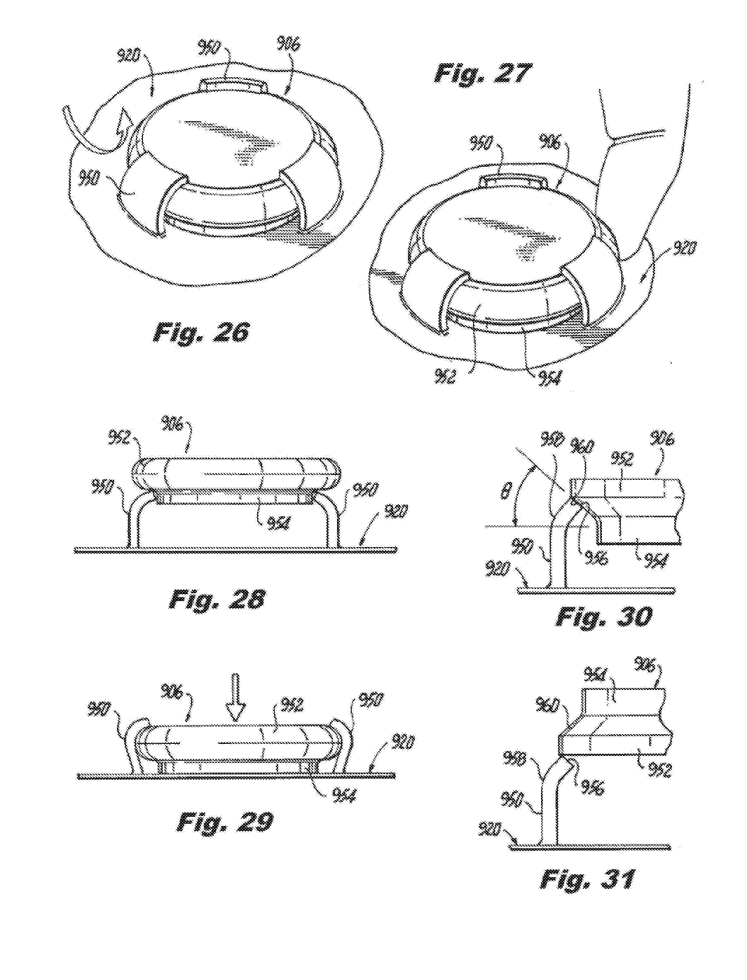

With reference now to FIG. 26, another exemplary embodiment of a monitoring device 906 and receptacle 920 are described, which can be used with packages such as those described above. Receptacle 920 includes a plurality of arms 950 configured to engage monitoring device peripherally 906, and to release monitoring device 906 by overcoming a bias in one or more of the arms 950. In FIG. 26, the bias is indicated by the arrow in the upper right, and the force for removing the monitoring device is indicated by the double arrow at the lower left, which schematically indicates a movement or force against the arm 250 at the upper right, and then upward away from the receptacle 920. FIG. 27 shows how these forces can be applied by way of example, with a user's finger applying the forces on an under side of an upper section 952 of monitoring device 906. Monitoring device 906 also includes a lower section 954 with a smaller area than that of the upper section 952 so that the monitoring device can be removed from the receptacle by pressing laterally against the lower section and applying an upward force against the upper section 952, as indicated in FIGS. 26 and 27.

The arms 950 of the receptacle 920 are dimensioned to receive lower section 954 first, as shown in FIG. 28, without the need for significant force. This prepositioning aligns monitoring device 906 with receptacle 920. Thereafter, application of a downward force, as oriented and indicated in FIG. 29, overcomes the bias of arms 950 to seat monitoring device 906 in receptacle 920. Each arm 950 of receptacle 920 includes a first cam surface 956 configured to expand the arm 950 over upper section 952 of monitoring device 906 when monitoring device 906 is advanced into arms 950 starting with the lower section 954 first as indicated in FIGS. 28, 29, and 30. A second cam surface 958 on each arm 950 is configured to resist advancing the monitoring device 209 into the receptacle 920 the wrong way, e.g., with upper section 952 inserted first, as indicated in FIG. 31. A cam surface 960 is included on monitoring device 906 connecting between the upper and lower sections 952 and 954, wherein the cam surface 960 is configure to cooperate with the first cam surface 956 to facilitate expansion of the arms 950 over the upper section 952 of the monitoring device 906 when the monitoring device 906 is advanced into the receptacle 920.

As shown in FIGS. 26-31, monitoring device 906 defines a substantially circular periphery, and there are three arms 950 that are substantially evenly spaced apart circumferentially. However, those skilled in the art will readily appreciate that any suitable number of arms, and any suitable peripheral shape can be used without departing from the scope of this disclosure. It will also be noted that while depicted herein with packs with multiple compartments for containing pills, tablets or the like, those skilled in the art will readily appreciate that this can be adapted for any other suitable items such as syringes or vials.

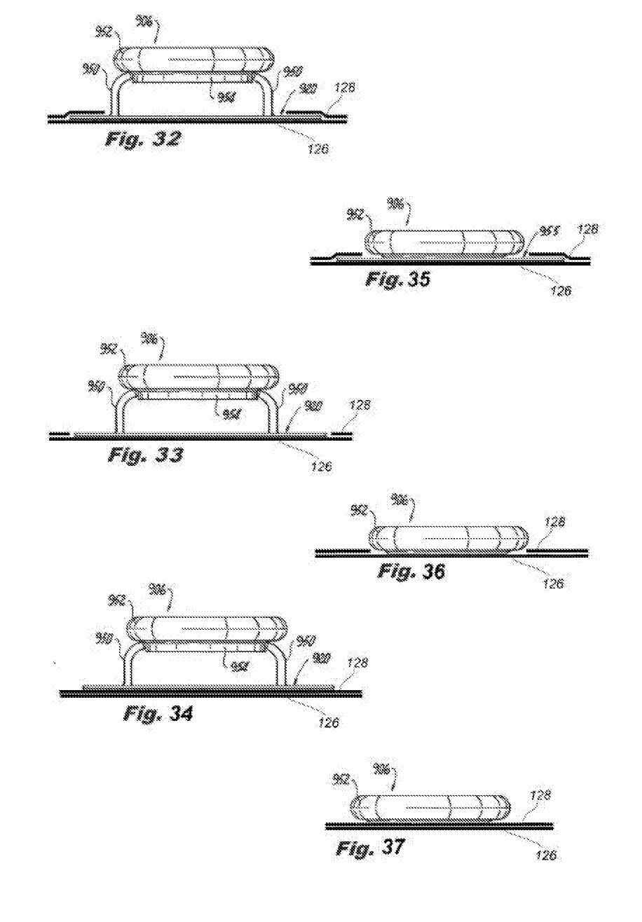

As shown in FIGS. 32-37, various attachment methods may be used to secure the monitoring device 906, or its receptacle 920, to the flaps 126, 128 (or to the outer sleeve if such attachment is preferred). In FIG. 32-37, an adhesive or other material is not shown for achieving the attachment, but it is to be understood that adhesive, heat seal, or other material may be utilized in the attachment. As shown in FIG. 32, receptacle 920 may have a flange 920 that may be heat sealed or otherwise secured between flaps 126, 128. In this case an opening may be made in flap 128 (or flap 126) sufficiently large to pass the three arms 950 but not the base 920. Alternately as shown in FIG. 33, receptacle 920 may be secured to the inner surface of flap 126 and an opening provided in flap 128 sufficient to receive the receptacle base. Alternately as shown in FIG. 34, the receptacle may simply be secured to the outer surface of flap 128, without any openings needed in the flaps to accommodate the receptacle base.

FIGS. 35-37 show attachment methods where the monitoring device 906 is secured without using a receptacle 920. As shown in FIG. 35, the monitoring device 906 may have its own flange 955 that may be trap-sealed between flaps 126, 128. In this case an opening may be made in flap 128 (or flap 126) sufficiently large to pass the monitoring device 906 except for its flange 955. Alternately as shown in FIG. 36, monitoring device 906 may be secured to the inner surface of flap 126 and an opening provided in flap 128 sufficient to receive monitoring device. Alternately as shown in FIG. 37, the monitoring device 906 may simply be secured to the outer surface of flap 128, without any openings needed in the flaps to accommodate the monitoring device.

While shown and described in the exemplary context of using switches, those skilled in the art will readily appreciate that any suitable type of switch or sensor, digital or analog, that can detect the movements, transformations, translations, and the like as described herein, can be used without departing from the scope of this disclosure.

While shown and described in the exemplary context of the package contents being blisters, those skilled in the art will readily appreciate that other contents such as syringes, vials, etc may be contained in the package.

The methods and systems of the present disclosure, as described above and shown in the drawings, provide for packages with superior properties including improved monitoring such as for dosage monitoring. While the apparatus and methods of the subject disclosure have been shown and described with reference to preferred embodiments, those skilled in the art will readily appreciate that changes and/or modifications may be made thereto without departing from the scope of the subject disclosure.

1. A package comprising:
an outer sleeve;
a slide card slidingly received in the outer sleeve;
a monitoring device operatively connected to the package to generate data indicative of use of the package; and
a switch electrically connected to the monitoring device for activating and deactivating the monitoring device, wherein at least part of the switch is mounted on the slide card such that the switch is operated to activate or deactivate the monitoring device by one of translating movement of the slide card relative to the outer sleeve or transforming movement of the slide card.

2. The package as recited in claim 1, wherein the monitoring device is configured to record the time and date when the monitoring device is activated and/or deactivated.

3. (canceled)

4. (canceled)

5. (canceled)

6. (canceled)

7. (canceled)

8. (canceled)

9. (canceled)

10. (canceled)

11. The package as recited in claim 1, wherein the switch is a magnetic switch comprising a switch main and a magnet for actuating the switch main, wherein both the magnet and the switch main are operatively mounted to the slide card at different locations.

12. The package as recited in claim 11, wherein the slide card comprises a base portion and a card flap, wherein the card flap is hingedly connected to the base portion for pivotal transforming movement with respect to the base portion between a closed position where the card flap is disposed proximately over the base portion and an opened position where the card flap is disposed aside the base portion, and wherein the switch is operated to activate or deactivate the monitoring device by the transforming movement of the card flap between the closed and opened positions.

13. The package as recited in claim 12, wherein the switch main is mounted to one of the base portion and the card flap for common movement therewith relative to the other of the base portion and the card flap, wherein the magnet is mounted to the other of the base portion and the card flap for common movement therewith relative to the one of the base portion and the card flap such that when the card flap is in the closed position, the switch main and magnet are in proximity with one another and when in the opened position, the switch main and magnet are spaced apart from one another.

14. The package as recited in claim 13, wherein the switch main is combined with the monitoring device into a single unit such that the single unit is mounted to the one of the base portion and the card flap.

15. The package as recited in claim 11, wherein when the slide card is fully received in the outer sleeve, the magnet and the switch main are both proximate a closed end of the outer sleeve.

16. The package as recited in claim 11, wherein when the slide card is fully received in the outer sleeve, the magnet and the switch main are both proximate an open end of the outer sleeve.

17. The package as recited in claim 1, wherein the switch is a mechanical switch.

18. The package as recited in claim 17, wherein the slide card is translatable between first and second positions such that in the first position, the slide card is fully received in the outer sleeve, and in the second position, the slide card is at least partially withdrawn from the outer sleeve, and wherein the switch is operated to activate or deactivate the monitoring device by the translating movement of the slide card between the first and second positions.

19. The package as recited in claim 18, wherein the switch is mounted to the slide card for common movement therewith relative to the outer sleeve, wherein the switch includes a sloped cam surface that in the first position is pressed by the outer sleeve to actuate the switch, wherein when the card flap is in the second position, the cam surface is released from the pressing force of the outer sleeve to actuate the switch, and wherein the cam surface is configured to cam inward against an open end of the outer sleeve as the slide card moves from the second position to the first position.

20. The package as recited in claim 17, wherein the slide card comprises a base portion and a card flap, wherein the card flap is hingedly connected to the base portion for pivotal transforming movement with respect to the base portion between a closed position where the card flap is disposed proximately over the base portion and an opened position where the card flap is disposed aside the base portion, and wherein the switch is operated to activate or deactivate the monitoring device by the transforming movement of the card flap between the closed and opened positions.

21. The package as recited in claim 20, wherein the switch is mounted to the base portion and includes a switch element, wherein when the card flap is in the closed position the switch element is pressed by the card flap to actuate the switch, wherein when the card flap is in the opened position, the switch element is released from the pressing force of the card flap to actuate the switch, and wherein the switch element is biased toward the card flap when the card flap is in the closed position.

22. (canceled)

23. A package comprising:
an outer sleeve;
a slide card slidingly received in the outer sleeve; and
a monitoring device detachably attached to the slide card to generate data indicative of use of the package.

24. (canceled)

25. (canceled)

26. The package as recited in claim 23, wherein the slide card includes a monitoring device receptacle including at least one dovetail rail, and wherein the monitoring device includes at least one respective dovetail channel, wherein the dovetail rail and channel are configured for sliding engagement and disengagement of the monitoring device with the slide card.

27. The package as recited in claim 26, wherein the dovetail rail includes a terminus having a greater rail height than the remainder of the dovetail rail, and wherein the dovetail channel has a terminus having a greater channel depth than the remainder of the channel, wherein the terminus of the dovetail rail and the terminus of the dovetail channel engage one another with the monitoring device seated in the receptacle to retain the engagement of the monitoring device and the receptacle while allowing for deliberate disengagement thereof.

28. The package as recited in claim 23, wherein the slide card includes a monitoring device receptacle including a plurality of arms configured to engage the monitoring device peripherally, and to release the monitoring device by overcoming a bias in one or more of the arms.

29. (canceled)

30. The package as recited in claim 28, wherein the monitoring device includes an upper section and a lower section, wherein the lower section has a smaller area than that of the upper section so that the monitoring device can be removed from the receptacle by pressing laterally against the lower section and applying an upward force against the upper section.

31. The package as recited in claim 30, wherein the arms of the receptacle are dimensioned to receive the monitoring device lower section first without force.

32. The package as recited in claim 31, wherein at least one of the arms of the receptacle includes a first cam surface configured to expand the arm over the upper section of the monitoring device when the monitoring device is advanced into the arms lower section first and a second cam surface configured to resist advancing the monitoring device into the receptacle upper section first.

33. The package as recited in claim 32, wherein a cam surface is included on the monitoring device connecting between the upper and lower sections, wherein the cam surface of the monitoring device is configure to cooperate with the first cam surface of the receptacle to facilitate expansion of the one or more arms of the receptacle over the upper section of the monitoring device when the monitoring device is advanced into the receptacle.
